(19) United States
(12) Patent Application Publication
(10) Pub. No.: US 2013/0235203 A1
(43) Pub. Date: Sep. 12, 2013

(54) INDICIA IDENTIFYING SYSTEM

(71) Applicants: Peter Eric Billington, Sheffield (GB); Christopher Michael Wallett, Sheffield (GB)

(72) Inventors: Peter Eric Billington, Sheffield (GB); Christopher Michael Wallett, Sheffield (GB)

(73) Assignee: TELEMATICS TECHNOLOGY LLP, Sheffield (GB)

(21) Appl. No.: 13/811,016

(22) PCT Filed: Jul. 20, 2011
(86) PCT No.: PCT/GB2011/001089

§ 371 Date: May 31, 2013

(30) Foreign Application Priority Data
Jul. 20, 2010 (GB) 1012178.8

(51) Int. Cl. G08G 1/017

(52) U.S. Cl. CPC G08G 1/0175
USPC 348/148

(57) ABSTRACT

The present invention relates to an indicium identifying system. The system comprises at least one image sensor (100) for imaging an indicium; an illuminator (102) for illuminating said indicium; and a processor (104) adapted to receive images of the indicium from the at least one image sensor (100) and process said image to determine said indicium, wherein the illuminator (102) is adapted to emit a series of light pulses of varying intensity. This invention extends to a corresponding method.

The present invention relates to an indicia identifying system. In particular, the invention relates to a system that utilises laser and/or LED illumination, and is powered by renewable energy sources such as solar or wind. The present invention extends to a corresponding method.

### BACKGROUND

Indicia identifying camera systems, such as ANPR (automatic number plate recognition) systems, are known. The systems incorporate a camera, a form of illumination (most commonly an incandescent light source) and a processor for processing the images captured by the camera to determine the indicia (such as a vehicle license plate).

### STATEMENTS OF INVENTION

According to one aspect of the invention, there is provided, an indicium identifying system comprising: at least one image sensor for imaging an indicium; an illuminator for illuminating said indicium; and a processor adapted to receive images of the indicium from the at least one image sensor and process said image to determine said indicium, wherein the illuminator is adapted to emit a series of light pulses of varying intensity.

Preferably, the exposure of said image sensor is adapted to synchronise with said series of light pulses.

Preferably, said series of light pulses comprises light pulses with differing power.

Preferably, said light pulses have relatively low power and relatively high power.

Preferably, the light pulses of differing power are interspersed with one another.

In an example, the series of light pulses includes substantially the same number of relatively low power and relatively high power light pulses. In an alternative example, the series of light pulses includes a greater number of said relatively high power light pulses than said relatively low power light pulses. In yet an alternative example, the series of light pulses includes a greater number of said relatively low power light pulses than said relatively high power light pulses.

Preferably, the indicium is in the form of a vehicle number plate and wherein the illuminator is adapted to emit light pulses of a first relatively low intensity suitable for illuminating retro-reflective number plates, and a second relatively high intensity suitable for illuminating non-retro-reflective number plates.

Preferably, the light pulses of relatively high intensity ₐre of a sufficient intensity so as to illuminate a vehicle upon which said number plate is locatable thereby to enable the capture of an overview image. In this way it is possible to identify the vehicle type, make and model.

Preferably, the light pulses are of a sufficient intensity to illuminate the indicium and/or an area around the indicium in conditions of both daylight and darkness.

Preferably, the duration of the light pulses is in the range of between 5 μs and 4 ms, and preferably between 10 μs and 2 ms.

Preferably, the system further comprises at least one object detector adapted to detect the presence of a moving object within the field of view of said at least one image sensor.

Preferably, said at least one object detector is further adapted to output a trigger signal, when an object is detected, to initiate said illuminator.

Preferably, said at least one object detector comprises an optical sensor adapted to detect reflections from said object of relatively low power light emitted from said illuminator, and wherein said trigger signal initiates said illuminator to emit said series of light pulses of varying intensity.

Preferably, the illuminator is adapted to emit a series of light pulses of low power and short duration for use in detecting the presence of a moving object.

Preferably, the pulses in said series of pulses for detecting a moving object are of a shorter duration than the illumination pulses, and preferably of a significantly shorter duration.

Thus, the system initially operates in a “low power” mode, where the illuminator only emits a series of short duration low power pulses for detecting the presence of a vehicle within the field of view of the system. Once a vehicle has been detected, the system is triggered into an “active mode” in which the illuminator emits the series of pulses of varying intensity, including the relatively higher power pulses. This operation reduces the overall power consumption of the system, which hence reduces the size and cost of any renewable energy power source that might be used to power the system.

Preferably, said at least one object detector comprises at least one of: an opto-electronic sensor; and a pyroelectric sensor.

Preferably, the system further comprises at least one object detector adapted to detect the presence of an object moving in a first direction, and at least one object detector adapted to detect the presence of an object moving in a second direction.

To provide even illumination of the scene (necessary to achieve high quality images and high accuracy in the reading of identification marks) an array of light sources is utilised; this enables the illuminator to overcome the uneven illumination (often referred to as “speckle”) that results when using a small number of laser light sources.

Preferably, said illuminator comprises a plurality of light sources.

Preferably, said plurality of light sources are in the form of an array.

Preferably, said array of light sources are arranged in a grid.

Preferably, said array is formed from a plurality of sets of light sources.

Preferably, said plurality of sets of light sources are arranged to form an array having a convex surface.

Preferably, said illuminator is adapted to provide a field of illumination between 2 m and 20 m wide at a distance between 3 m and 50 m from the illuminator.

Preferably, said illuminator is adapted to provide a field of illumination between 2.5 m and 4.5 m wide at a distance between 10 m and 30 m from the illuminator, or the width of said field of illumination is between 5.5 m and 8.5 m at a distance between 15 m and 35 m from the illuminator, or the width of said field of illumination is between 9 m and 12 m at a distance between 20 m and 50 m from the illuminator.

Preferably, said image sensor is adapted to image a scene of between 2 m and 20 m wide at a distance between 3 m and 50 m from the illuminator.

Preferably, the illuminator is adapted to convert electrical energy to light energy with a high conversion efficiency.

Preferably, the illuminator is in the form of a laser illuminator

Preferably, said laser illuminator comprises at least one of: a solid state laser; a laser diode; and a vertical cavity surface emitting laser.

Preferably, the system further comprises a proximity detector adapted to turn off said laser illuminator when the presence of an object within a pre-determined distance of said laser illuminator is detected.

Preferably, said proximity detector is adapted to detect the presence of a human head.

Preferably, said illuminator is in the form of a light emitting diode (LED) illuminator.

Preferably, said illuminator emits light comprising substantially infra-red wavelengths.

Alternatively, or in addition, said illuminator emits light at substantially visible wavelengths.

Preferably, the system further comprises a power supply, wherein said power supply comprises means for obtaining energy from at least one renewable energy source.

Preferably, said renewable energy source is at least one of: solar energy; and wind energy.

Preferably, said power supply comprises at least one photo-voltaic cell.

Preferably, said power supply comprises at least one wind turbine.

Preferably, said power supply further comprises means for storing said renewable energy, and preferably wherein said storage means includes a battery.

Preferably, the system further comprises means for determining the location of said image sensor.

Preferably, said location determining means comprises a global positioning system (GPS) receiver.

Preferably, the system further comprises means for transferring data associated with an image captured by said image sensor to a remote server.

Preferably, said data includes information relating to at least one of: said indicium, the time of day said image was captured, the location of said image; and the object captured within said image.

Preferably, said transferring means is in the form of a wireless transceiver, and preferably said wireless transceiver being adapted to use at least one of the following communication protocols: GSM; GPRS; Edge; 3G; Wifi; and WiMax.

Preferably, said transferring means is a wired transceiver, preferably adapted to use at least one of the following communication protocols: RS232; USB; Ethernet; and ADSL.

Preferably, said processor is remote to said image sensor and illuminator, and the transferring means is adapted to transmit a raw image, with associated data, to said remote processor for processing.

Preferably, said indicium is on a vehicle.

Preferably, said indicium is one of: a retro-reflective number plate; a hazard warning plate; a non-retro-reflective number plate.

Preferably, said processor is further adapted to determine the type, make and/or model of vehicle captured by said image sensor.

According to another aspect of the invention, there is provided a method for identifying an indicium comprising: illuminating an indicium; imaging the illuminated indicium; and processing said image to determine said indicium, wherein the illumination step comprises illuminating the indicium using a series of light pulses of varying intensity.

Preferably, said series of light pulses comprises light pulses with differing power.

Preferably, said light pulses have relatively low power and relatively high power.

Preferably, the method further comprises emitting a series of light pulses of low power and short duration for use in detecting the presence of a moving object.

Preferably, the method further comprises triggering the illumination of said indicium using said series of light pulses of varying intensity in response to the detection of a moving object.

According to a another aspect of the present invention, there is provided an indicium identifying system comprising: at least one image sensor for imaging an indicium; a laser illuminator for illuminating the indicium; and a processor adapted to receive images of the indicium from the at least one image sensor and process the image to determine the indicium. By providing a laser illuminator, the efficiency of the system may be improved.

Preferably, the laser illuminator comprises a plurality of laser light sources, preferably in an array. By doing so the light provided by the illuminator may be more even, and may prevent “speckling”.

Preferably, the array of laser light sources are arranged in a grid. The array may be formed from a plurality of sets of laser light sources.

Preferably, the plurality of sets of laser light sources are arranged to form an array having a convex surface.

Preferably, the laser illuminator is adapted to provide a field of illumination between 2.5 m and 4.5 m wide at a distance between 10 m and 30 m from the laser illuminator, or the width of said field of illumination is between 5.5 m and 8.5 m, or the width of said field of illumination is between 9 m and 12 m. More preferably, the laser illuminator is arranged to provide a field of illumination suitable for illuminating a single, dual, triple or more, lane roadway.

The laser illuminator may comprise any one of a number of different types of laser, such as a solid state laser, a laser diode, or a vertical cavity surface emitting laser.

For a more effective system that may reduce distraction to individuals in the proximity of the system, the laser illuminator may emit light comprising substantially infra-red wavelengths.

The efficiency of the system may be further improved by adapting the laser illuminator to emit a series of light pulses. Preferably, the exposure of the image sensor is adapted to synchronise with the series of light pulses. In order to potentially increase the range of indicia that may be identified, the series of light pulses may comprise light pulses with differing power. More preferably, the light pulses have relatively low power and relatively high power.

Preferably, the system further comprises a power supply, wherein the power supply comprises means for obtaining energy from at least one renewable energy source. By providing a renewable power supply, the system may be located in more areas than conventional systems. More preferably, the renewable energy source is at least one of: solar energy, for example a photo-voltaic cell; and wind energy, for example a wind turbine.

Preferably, the power supply further comprises means for storing the renewable energy, preferably the storage means is a battery. By providing storage means the system may remain operational even when the renewable energy source is temporarily unavailable.

The system may further comprise an object detector adapted to detect the presence of a moving object within the field of view of the at least one image sensor. Preferably, the object detector is further adapted to output a trigger signal, when an object is detected, to initiate the laser illuminator. By providing an object detector, the system efficiency may be further improved as the laser illuminator is in a powered down state when no object is within the image sensors field of view.

Preferably, the object detector comprises an optical sensor adapted to detect reflections from the object of relatively low power laser light emitted from the laser illuminator, wherein the trigger signal initiates the laser illuminator to emit relatively high power laser light.

Preferably, the object detector comprises at least one of: an opto-electronic sensor; a pyroelectric sensor; a radar sensor; and an ultrasonic sensor.

The system may also comprise at least one object detector adapted to detect the presence of an object moving in a first direction, and at least one object detector adapted to detect the presence of an object moving in a second direction. By providing a plurality of object detectors, each adapted to sense the movement of objects in different directions, the system may be used to survey multi-lane carriageways.

The system may further comprise a proximity detector adapted to turn off the laser illuminator when the presence of an object within a pre-determined distance of the laser illuminator is detected. Preferably, the proximity detector is adapted to detect the presence of a human head. By providing a proximity detector, the safety of the system may be improved

The system may further comprise means for determining the location of the image sensor. More preferably, the location determining means comprises a global positioning system (GPS) receiver. By providing means for determining the system location, the installation procedure may be simplified.

The system may further comprise means for transferring data associated with an image captured by the image sensor to a remote server. Preferably, the data includes information relating to at least one of: the indicium, the time of day the image was captured, the location of the image; and the object captured within the image.

Preferably, the transferring means is a wireless transceiver, preferably the wireless transceiver is adapted to use at least one of the following communication protocols: GSM; GPRS; Edge; 3G; Wifi; and WiMax.

Preferably, the transferring means is a wired transceiver, more preferably the wired transceiver is adapted to use at least one of the following communication protocols: RS232; USB; Ethernet; and ADSL.

Preferably, the processor is remote to the image sensor and laser illuminator, wherein the transferring means is adapted to transmit a raw image, with associated data, to the remote processor for processing.

Preferably, the indicium is on a vehicle. More preferably, the indicium is one of: a retro-reflective number plate; a hazard warning plate; a non-retro-reflective number plate.

Preferably, the processor is further adapted to determine the type of vehicle captured by the image sensor.

According to a further aspect of the present invention, there is provided a method of identifying an indicium, comprising: illuminating an indicium using a laser illuminator, imaging the indicium using the laser illuminator as a light source, and processing the image to determine the indicium.

Preferably, the step of illuminating the indicium comprises, using laser light pulses of differing power. More preferably, the step of illuminating the indicium further comprises using at least one laser light pulse with a (relatively low) power suitable for illuminating a retro-reflective indicium, and at least one laser light pulse with a (relatively high) power suitable for illuminating a non-retro-reflective indicium.

The invention extends to any novel aspects or features described and/or illustrated herein.

Further features of the invention are characterised by the independent and dependent claims.

The invention extends to methods and/or apparatus substantially as herein described with reference to the accompanying drawings.

The invention also provides a computer program and a computer program product for carrying out any of the methods described herein and/or for embodying any of the apparatus features described herein, and a computer readable medium having stored thereon a program for carrying out any of the methods described herein and/or for embodying any of the apparatus features described herein.

The invention also provides a signal embodying a computer program for carrying out any of the methods described herein and/or for embodying any of the apparatus features described herein, a method of transmitting such a signal, and a computer product having an operating system which supports a computer program for carrying out any of the methods described herein and/or for embodying any of the apparatus features described herein.

Any apparatus feature as described herein may also be provided as a method feature, and vice versa. As used herein, means plus function features may be expressed alternatively in terms of their corresponding structure, such as a suitably programmed processor and associated memory.

Any feature in one aspect of the invention may be applied to other aspects of the invention, in any appropriate combination. In particular, method aspects may be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

Furthermore, features implemented in hardware may generally be implemented in software, and vice versa. Any reference to software and hardware features herein should be construed accordingly.

Apparatus and method features may be interchanged as appropriate, and may be provided independently one of another. Any feature in one aspect of the invention may be applied to other aspects of the invention, in any appropriate combination. In particular, method aspects may be applied to apparatus aspects, and vice versa.

Embodiments of this invention will now be described, by way of example only, with reference to the accompanying drawings, of which:

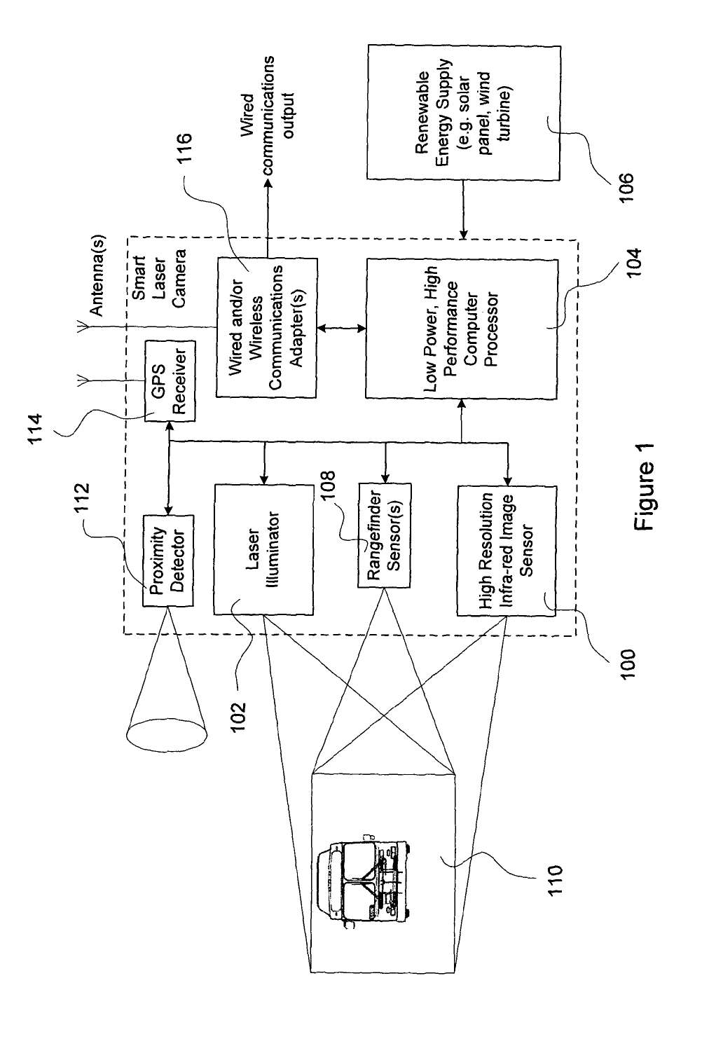

FIG. 1 shows a schematic diagram of the indicia identification system;

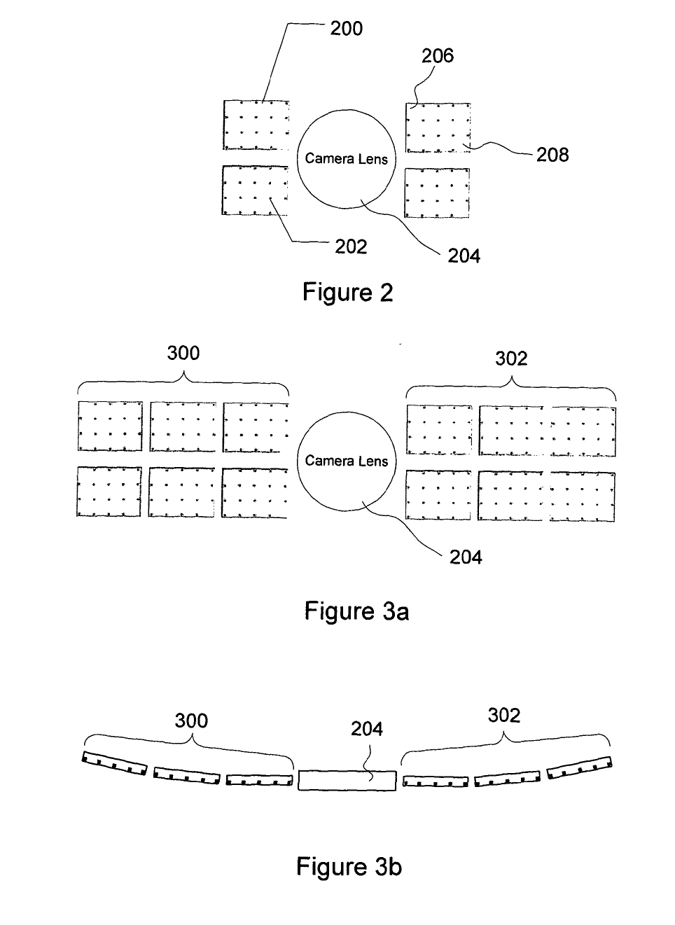

FIG. 2 shows a typical arrangement of the laser illuminator;

FIG. 3a shows an alternative arrangement of the laser illuminator;

FIG. 3b shows a plan view of the arrangement of the laser illuminator shown in FIG. 3a; and

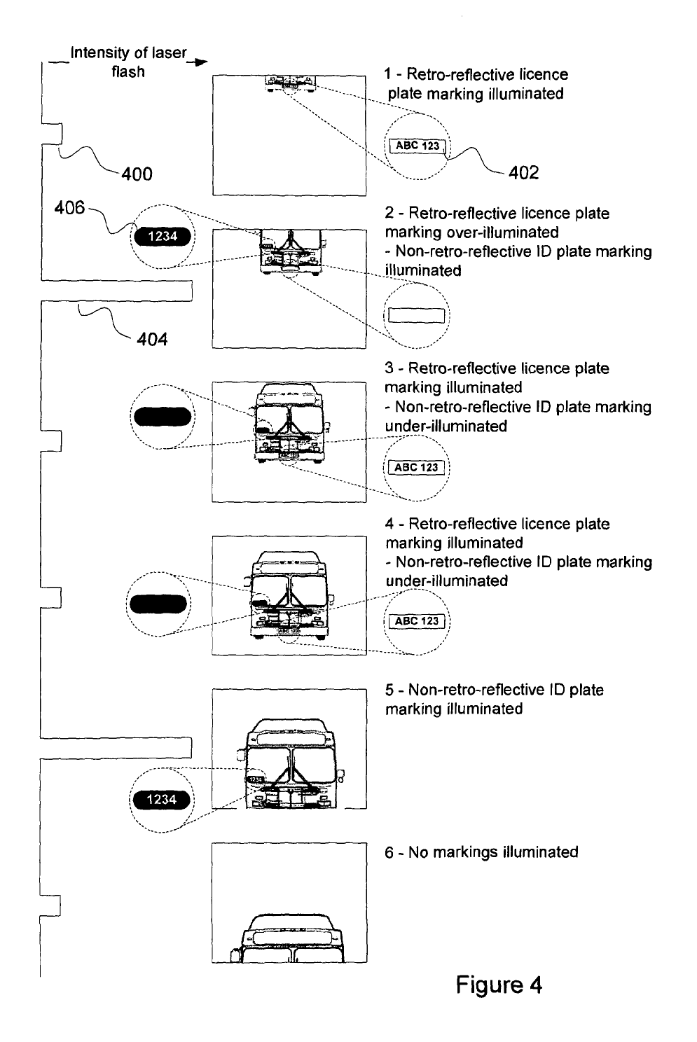

FIG. 4 shows a flow type diagram of the method of identifying retro-reflective and non-retro-reflective markings.

FIG. 1 shows a schematic diagram of the system comprising a high resolution infra-red image sensor 100. The image sensor is in communication with a laser illuminator 102, and a low power, high performance processor 104. The system is powered by a renewable energy supply 106, and this may be solar power (e.g. a photo-voltaic cell) or wind power (e.g. a wind turbine), or both. The laser illuminator is in connection with a rangefinder sensor 108 that enables the laser illuminator to remain in a low power state until an object is within the field of view 110 of the image sensor. In addition, the system is provided with a proximity detector 112 to determine whether an object, for example a human head, is too close to the laser illuminator. This enables the laser illuminator to be turned off to prevent the laser illuminator from damaging the eyes of humans. The system also comprises a GPS receiver 114 that enables the system to determine its location. Finally, the system is provided with a communications adapter 116 that enables the system to communicate (either wired or wirelessly) with an external server or the like.

In an alternative example (not illustrated in FIG. 1), a light emitting diode LED illuminator is provided instead of the laser illuminator 102, and the various features described herein with respect to the laser illuminator apply equally to the LED illuminator, as appropriate. In particular, the pulsed operation and array layout of the laser illuminator could be applied to the LED illuminator.

In use, the system reads automatically identification marks on motor vehicles (such as license plates, hazard warning panels, etc) and transmits the identification details and other associated data and images wirelessly (or wired) to a remote receiver (such as a server or the like). As the system utilises a laser illuminator, the system uses low levels of electrical power such that an entirely self-contained installation is possible that can be powered by renewable energy supplies such as photo-voltaic panels and wind turbines. This enables the system to be positioned quickly in any location, in particular where a mains electrical power supply or wired communication links are not readily available.

The invention incorporates a pulsed laser illuminator that provides a high level of light output at a low level of electrical power consumption. Typically, infra-red wavelengths are used so that identification marks on any surface of a vehicle (including the front, sides, rear and top) can be read without the driver or vehicle occupants being distracted by visible illumination. The laser illuminator, as with conventional laser sources, emits substantially coherent light; the lasers used produce an area of light whose size and shape can be adjusted as required through the use of diverging lenses. Typically, the cross-section of the light beam emitted by each laser source in the laser illuminator is substantially circular, but where required the light can be shaped into an ellipse.

To provide even illumination of the scene (necessary to achieve high quality images and high accuracy in the reading of identification marks) an array of laser light sources is utilised; this enables the laser illuminator to overcome the uneven illumination (often referred to as “speckle”) that results when using a small number of laser light sources.

FIG. 2 shows a typical arrangement of the array of laser sources in the laser illuminator 102. As can be seen, the laser modules 200, each carrying multiple laser sources 202 are arranged around the camera (image sensor) lens 204. Each module contains a set of multiple laser sources arranged in a grid; in each module, the spaces 206, 208 indicating an absence of a laser source allow for the module to be connected to each other laser module.

FIGS. 3a and 3b show an alternative array of laser sources. As can be seen each set of laser modules 300 and 302 is arranged either side of the camera (image sensor) lens 204. In this arrangement, the laser modules are arranged to form a convex surface thereby increasing laterally the field of illumination provided by the laser illuminator. Additional modules can be added to further increase the field of illumination where necessary.

The laser modules can be arranged to form an array that provides a field of illumination suitable for the location where the system is placed. For example, where the system is monitoring a single lane road, the field of illumination may be created using an arrangement as shown in FIG. 2, and might have a width of approximately 3.5 m at a distance of 10 m to 30 m from the laser illuminator. Alternatively, where the system is monitoring a three (or more) lane motorway, an arrangement as shown in FIGS. 3a and 3b may be more suitable, and might have a width of 10.5 m, 14 m or more at a distance of 20 m to 50 m.

The array of laser sources may be arranged to form a field of illumination in the shape of a lozenge; i.e. a rectangular shape with semi-circular ends (such as an oval or quasi-ellipse).

The efficiency of the laser array (the light output power compared to the electrical input power) is much higher than that of illuminators commonly used to illuminate vehicle identification marks (which typically use incandescent or conventional (non-lasing) LED light sources). As a result, the use of renewable energy sources (such as photo-voltaic panels and wind turbines) may become practical for applications where a large area is to be illuminated, such as the entire width of multiple lane carriageways. In such applications the use of conventional sources of illumination requires solar panels or wind turbines of a size which is not cost-effective.

FIG. 4 shows a flow type diagram of the method of identifying retro-reflective and non-retro-reflective markings. As can be seen, the laser illuminator is used to enable the reading of both retro-reflective and non-retro-reflective vehicle markings. A lower power level of laser light output 400 is used to illuminate retro-reflective markings 402 (which reflect incident light back towards the camera) and a higher power level of laser light output 404 is used to illuminate non-retro-reflective vehicle markings 406 (which scatter incident light so that only a small proportion is reflected back towards the camera).

In order to illuminate and capture images of both retro-reflective and non-retro-reflective markings which are in the field of view of the camera either sequentially or simultaneously, a pattern of laser pulses (synchronized with the exposure of the image sensor) is used where low-level pulses are interspersed with high-level pulses and the level can be changed between the exposure of one frame and the next.

In addition to illuminating non-retro-reflective identification marks, high level pulses also enable images to be captured of the vehicle itself, particularly at night. Such images can be used for example for automated classification of the vehicle type, and to enable the vehicle make and model to be identified. The system allows such images to be captured at the same time that the camera is carrying out recognition of both retro-reflective and non-retro-reflective identification marks.

To reduce the electrical power consumption, high-level laser pulses are used only when there is a vehicle in the field of view of the camera. The system uses a “Rangefinder” mode whereby very short laser pulses are output from the illuminator (which are not intended for scene illumination) and their reflections are detected by a separate optical sensor. When the presence of a vehicle is detected by this method, the illuminator switches to a mode where high level laser pulses are output to illuminate non-retro-reflective markings. Alternative methods of vehicle presence detection can be used such as pyro-electric infra-red (PIR), radar or ultrasonic sensors.

In terms of the requirements for eye safety, the levels of infra-red light output by the laser illuminator are higher than those normally associated with a Class 1 or Class 1M laser device. To achieve compliance with the eye safety requirements for a Class 1 or Class 1M device, a proximity detector is incorporated which automatically shuts off the illuminator in the event that an object (in particular a human head) is detected closer to the illuminator than the no-hazard viewing distance.

The integration of a high resolution image sensor, a low power, high performance computer processor and a laser illuminator into a single unit provides a system capable of the automated reading of identification marks on vehicles across several lanes of a multiple lane carriageway using a single device which can be powered cost-effectively from renewable energy sources.

The system can also be constructed in other configurations where the laser illuminator, high-resolution image sensor, low power high performance computer processor and wireless communications adapter(s) are contained, either singly or in any combination, in separate units interconnected using wired or wireless means.

### Image Capture

Infra-red light is used to illuminate vehicles in order to enable images to be captured of identification marks at any time of day or night, regardless of the colour, reflectivity or state of cleanliness of the markings and in almost any environmental conditions. The laser illuminator 102 can incorporate any type of laser light source including solid state lasers, laser diodes or VCSELs (Vertical Cavity Surface Emitting Lasers).

Infra-red illumination is used which is generally invisible to the unaided human eye so that identification marks in particular on the fronts of vehicles can be illuminated without dazzling or distracting the driver or other vehicle occupants.

An infra-red laser illuminator generates short pulses of infra-red light in synchronization with the exposure of a high-resolution image sensor having a response at the appropriate infra-red wavelength. The pulses and time of exposure are sufficiently short so that images of vehicles travelling at high speeds can be captured without noticeable motion blur.

The frequency of pulses (and associated exposures)—known as the frame rate—is sufficiently high such that each individual vehicle is captured in a number of successive frames as it passes through the field of view of the image. The frame rate is sufficiently high such that multiple images are captured even of vehicles travelling at high speeds.

The intensity of the light output from the illuminator is varied from one pulse to the next in order to provide good contrast images of a variety of identification marks including those which are retro-reflective (i.e. which reflect light back towards the location of the light source) and those which are non-retro-reflective (including both matt and reflective surfaces) and tend to scatter incident light. The intensity of the pulses intended to illuminate non-retro-reflective markings is many times that of the pulses intended to illuminate retro-reflective markings.

In addition to illuminating non-retro-reflective identification marks, the high intensity laser pulses are sufficient to illuminate the vehicle itself, such that an image can be captured from which the type of vehicle (useful for classification), the make and the model can be identified—either by automated image analysis or by presentation of the image to a human operator who identifies the vehicle type, make and model. During the day, such images may be captured without the use of a laser illuminator (there is generally sufficient infra-red illumination from the sun). However at night, without substantial additional artificial illumination, a typical ANPR camera captures an image which shows only retro-reflective markings and the light from the vehicle headlights—the vehicle itself cannot generally be seen.

Furthermore, within the two bands of illumination intensity, the flash intensity, image sensor exposure time and frame rate are varied frame by frame under control of the computer processor in order to obtain good contrast images of the markings of interest on each individual vehicle regardless of the vehicle speed, age, state of cleanliness or the prevailing conditions.

The field of view of the image sensor can cover several lanes of traffic such that multiple vehicles are captured in a single frame. The frame by frame variations in illumination and exposure over a sequence of frames permit the capture of good contrast images of a variety of identification marks from every vehicle passing through the field of view at any given time.

FIG. 4 illustrates a sequence of images captured by the image sensor and the associated pattern of illuminator pulses.

One of the considerations when using laser illumination is that of eye safety. Even though infra-red light is invisible to the unaided human eye, excessive exposure can nevertheless cause, for example, retinal damage. Since the pattern of illumination from the camera illuminator is divergent, there is only an issue regarding photobiological safety when the eye is in close proximity to the laser source. Therefore the camera incorporates a proximity detector which, via a fail-safe circuit, switches off the illuminator when an object (for example a human head) is detected closer to the laser source than the distance at which eye safety is assured.

### Image and Data Processing

Frames captured by the high resolution image sensor are digitized and processed by the computer processor (which may be integrated into the camera or housed in a separate enclosure connected via a wired or wireless communications link) which executes algorithms to carry out automatic detection and recognition of vehicle identification marks in each frame. That is to say the output of the process is digital data including the specific alphabetic, numeric and symbolic characters incorporated in each individual identification mark.

The computer processor also provides various data management functions, such as the storage in and retrieval from a database of vehicle images and associated data (including identification marks, time and date of detection, camera ID, geographic coordinates of the camera location and other relevant details). Also stored in the database are camera configuration data, camera diagnostic information and ancillary data such as tables of identification marks relating to black lists and white lists.

Data and images from the database can be transmitted by the camera to one or more remote systems (such as a back office server or instation) via one or more wired or wireless communication links (including RS232, USB, Ethernet, ADSL, GSM/GPRS/Edge/3G, Wifi, WiMax etc). The camera can be configured to transmit data continuously, periodically or on demand, using a variety of industry standard and proprietary protocols. Alternatively, data can be accumulated in the database and downloaded in bulk to a computer connected locally via one of the aforementioned communication channels.

The camera incorporates a GPS receiver and antenna, such that when it is deployed, the camera is able accurately to determine its own location in the form of geographic co-ordinates. The GPS receiver also provides an accurate time source for synchronization of the computer processor internal clock. The geographic co-ordinates can then be associated with any transmitted data and embedded into transmitted images so that, in addition to the time and date, the precise location of any recognised identification marks is always known. A further benefit of incorporating GPS is that there is no need for the installer to make and record manual GPS readings in order to know the camera location.

### Power Supply and Consumption

The laser illuminator is efficient in terms of the conversion of electrical power to infra-red light. It therefore requires substantially less electrical power than conventional illuminators using incandescent or conventional (non-lasing) LED sources which are significantly less efficient. Since the computer processor and associated devices also consume low levels of power (comparable to a mobile phone for example) then it is viable to power the camera from a photovoltaic (solar) panel and associated storage battery of moderate size and cost. In areas with an appropriate climate, it is possible to use a small wind turbine either instead of or in addition to a photovoltaic panel.

The most significant power consumption of the laser illuminator occurs during the production of the high intensity infra-red pulses used to illuminate non-retro-reflective identification marks. Therefore to reduce the overall power requirement, and the size and cost of photovoltaic panel and associated battery, the camera incorporates one or more low power “rangefinder” sensors which are used to detect the approach of vehicles towards the camera field of view by their reflection of short, low-intensity infra-red laser pulses which are emitted continuously. This reflection can occur from any part of the vehicle, not specifically identification marks.

The mode of operation is therefore that the illuminator operates in a low power mode (i.e. does not produce high-intensity pulses) until the approach of a vehicle is detected. At this point, the production of high intensity pulses commences for a period of time, during which non-retro-reflective identification markings can be detected. The production of high intensity pulses is then continued until either (i) a period of time has elapsed in which no identification marks have been detected (ii) identification marks have been detected and tracked through the camera field of view such that it is known that the vehicle is no longer in the field of view.

Since the camera is able to detect and read identification marks from vehicles in multiple lanes, potentially having vehicles travelling in different directions, then multiple rangefinder sensors may be installed in relevant applications in order to detect vehicles approaching the camera field of view from different directions. Other types of sensor (such as pyro-electric infra-red, radar or ultrasonic) may be used to detect the approach of vehicles instead of or in addition to rangefinder sensors.

In summary, the invention provides at least the following features and/or advantages:
1. A system which provides multi-level illumination intensity
(This is possible with either a pulsed laser or pulsed LED illuminator which has a sufficiently high optical power output.)
This feature may afford at least the following advantages:
   (i) detection and recognition simultaneously of both retro-reflective and non-retro-reflective vehicle markings both during daytime and nighttime operation
   (ii) capture of overview images (in which the type of vehicle, its make and model can be discerned) using the same sensor and illuminator as used for ANPR and at the same time that images used for ANPR are captured, and during both daytime and nighttime
   (iii) where the camera has a field of view covering several lanes of traffic, capture of multiple vehicles simultaneously in different lanes having either retro-reflective or non-retro-reflective markings
2. A triggering system using one or more optical detectors to detect reflection from vehicles of very short pulses emitted by the same illuminator as used for the recognition of markings
(This is possible with either a pulsed laser or pulsed LED illuminator which has a sufficiently high optical power output.)
This feature may afford at least the following advantages:
   (i) substantially reduced power consumption of both the illuminator (which uses very short pulses) and the processor (which can be put into “sleep” mode until a vehicle is detected)
   (ii) practical operation of the camera/illuminator from renewable energy sources e.g. from photo-voltaic panels of modest size
3. An array of many laser and/or LED sources
This feature may afford at least the following advantages:
   (i) even illumination throughout the camera field of view without the “speckle” normally associated with laser/LED illumination
   (ii) further enhanced low power operation due to the high efficiency with which lasers convert electrical energy into light energy

It is of course to be understood that the invention is not intended to be restricted to the details of the above embodiments which are described by way of example only, and modifications of detail can be made within the scope of the invention.

Each feature disclosed in the description, and (where appropriate) the claims and drawings may be provided independently or in any appropriate combination.

Reference numerals appearing in the claims are by way of illustration only and shall have no limiting effect on the scope of the claims.

1. An indicium identifying system comprising: at least one image sensor for imaging an indicium; an illuminator for illuminating said indicium; and a processor adapted to receive images of the indicium from the at least one image sensor and process said image to determine said indicium, wherein the illuminator is adapted to emit a series of light pulses of varying intensity.

2. A system according to claim 1, wherein the exposure of said image sensor is adapted to synchronise with said series of light pulses.

3. A system according to claim 1, wherein said series of light pulses comprises light pulses with differing power.

4. A system according to claim 3, wherein said light pulses have relatively low power and relatively high power.

5. A system according to claim 3, wherein the light pulses of differing power are interspersed with one another.

6. A system according to claim 4, wherein the series of light pulses includes substantially the same number of relatively low power and relatively high power light pulses.

7. A system according to claim 4, wherein the series of light pulses includes a greater number of said relatively high power light pulses than said relatively low power light pulses.

8. A system according to claim 4, wherein the series of light pulses includes a greater number of said relatively low power light pulses than said relatively high power light pulses.

9. A system according to claim 1, wherein the indicium is in the form of a vehicle number plate and wherein the illuminator is adapted to emit light pulses of a first relatively low intensity suitable for illuminating retro-reflective number plates, and a second relatively high intensity suitable for illuminating non-retro-reflective number plates.

10. A system according to claim 9, wherein the light pulses of relatively high intensity are of a sufficient intensity so as to illuminate a vehicle upon which said number plate is locatable thereby to enable the capture of an overview image.

11. A system according to claim 1, wherein the light pulses are of a sufficient intensity to illuminate the indicium and/or an area around the indicium in conditions of both daylight and darkness.

12. A system according to claim 1, wherein the duration of the light pulses is in the range of between 5 μs and 4 ms, and preferably between 10 μs and 2 ms.

13. A system according to claim 1, further comprising at least one object detector adapted to detect the presence of a moving object within the field of view of said at least one image sensor.

14. A system according to claim 13, wherein said at least one object detector is further adapted to output a trigger signal, when an object is detected, to initiate said illuminator.

15. A system according to claim 14, wherein said at least one object detector comprises an optical sensor adapted to detect reflections from said object of relatively low power light emitted from said illuminator, and wherein said trigger signal initiates said illuminator to emit said series of light pulses of varying intensity.

16. A system according to claim 13, wherein the illuminator is adapted to emit a series of light pulses of low power and short duration for use in detecting the presence of a moving object.

17. A system according to claim 16, wherein the pulses in said series of pulses for detecting a moving object are of a shorter duration than the illumination pulses, and preferably of a significantly shorter duration.

18. A system according to claim 13, wherein said at least one object detector comprises at least one of: an opto-electronic sensor; and a pyroelectric sensor.

19. A system according to claim 13, comprising at least one object detector adapted to detect the presence of an object moving in a first direction, and at least one object detector adapted to detect the presence of an object moving in a second direction.

20. A system according to claim 1, wherein said illuminator comprises a plurality of light sources.

21-57. (canceled)
